(19) United States
(12) Patent Application Publication
(10) Pub. No.: US 2023/0304962 A1
(43) Pub. Date: Sep. 28, 2023

(54) GAS SENSOR

(71) Applicant: NGK INSULATORS, LTD., Nagoya (JP)

(72) Inventors: Keita KAYANO, Nagoya (JP); Akari YAMADA, Nagoya (JP); Yuta MURAKAMI, Nagoya (JP)

(21) Appl. No.: 18/187,024

(22) Filed: Mar. 21, 2023

(30) Foreign Application Priority Data
Mar. 24, 2022 (JP) 2022-048718

(51) Int. Cl. G01N 27/407; G01M 15/10; G01N 27/406

(52) U.S. Cl. CPC G01N 27/4071; G01M 15/102; G01N 27/4062; G01N 27/4077

(57) ABSTRACT

A gas sensor includes a sensor element, at least one powder compact, and at least one dense body. The sensor element includes an element body, a detection portion, at least one connector electrode, a porous layer, and a water intrusion reducing portion. The water intrusion reducing portion includes a plurality of dense layers that are arranged at intervals in the longitudinal direction and have a porosity of less than 10%, each of the plurality of dense layers being disposed such that a position thereof in the longitudinal direction overlaps an inner circumferential surface of any of the at least one dense body.

### CROSS-REFERENCE TO RELATED APPLICATION

The present application claims priority from Japanese application JP2022-048718, filed on Mar. 24, 2022, the contents of which is hereby incorporated by reference into this application.

### BACKGROUND OF THE INVENTION

### 1. Field of the Invention

The present invention relates to a gas sensor.

### 2. Description of the Related Art

A gas sensor including a sensor element that detects the concentration of a specific gas such as NOx in a measurement-object gas such as an exhaust gas of an automobile is a known art (see, for example, PTL 1). The gas sensor in PTL 1 includes a sensor element, two powder compacts, and three insulators. The sensor element includes an element body, a detection portion, upper connector electrodes, a porous layer, and a water intrusion reducing portion. The detection portion includes a plurality of electrodes disposed on the forward end side of the element body. The connector electrodes are disposed on the rear end side of a prescribed side surface of the element body. The porous layer covers at least the forward end side of the prescribed side surface and has a porosity of 10% or more. The water intrusion reducing portion is disposed on the prescribed side surface so as to divide the porous layer in the longitudinal direction of the element body or to be located rearward of the porous layer and is located forward of the upper connector electrodes, and an overlap distance that is the length of a continuous overlapping portion between a forward-rearward region in which the water intrusion reducing portion is present and a forward-rearward region in which the inner circumferential surface of one of the insulators is present is 0.5 mm or more. The water intrusion reducing portion includes a dense layer having a porosity of less than 10% and reduces the capillary action of water in the longitudinal direction.

### CITATION LIST

### Patent Literature

PTL 1: WO 2019/155866 A1

### SUMMARY OF THE INVENTION

Even with the above-described gas sensor, the water intrusion reducing portion having the dense layer can prevent the water (water and sulfuric acid dissolved in water) moving beyond the water intrusion reducing portion to the rear end side of the sensor element and reaching the connector electrodes to some extent. However, assuming that the gas sensor is used in a severer environment, there is a demand to further prevent the water reaching the connector electrodes.

It is a main object of the present invention to further prevent the water reaching the connector electrodes in the gas sensor.

To achieve the above main object, the gas sensor of the present invention employs the following configuration.

The gas sensor of the present invention is a gas sensor including: a sensor element; a cylindrical member having a through hole through which the sensor element passes in an axial direction; at least one powder compact disposed inside the through hole and filled into a space between an inner circumferential surface of the through hole and the sensor element; and at least one hollow columnar dense body which has a porosity of less than 10% and is disposed inside the through hole, through which the sensor element passes, and which presses the powder compact in the axial direction, wherein the sensor element includes: an elongate element body that has at least one side surface extending in a longitudinal direction and forward and rear ends that are ends opposite to each other in the longitudinal direction; a detection portion that includes a plurality of electrodes disposed on a forward end side of the element body and configured to detect a specific gas concentration in a measurement-object gas; at least one connector electrode that is disposed on a rear end side of a prescribed one of the at least one side surface and provided for electrical continuity with the outside; a porous layer that covers at least a forward end side of the prescribed side surface and has a porosity of 10% or more; and a water intrusion reducing portion disposed on the prescribed side surface so as to be located rearward of at least part of the porous layer and to be located forward of the connector electrode, and wherein the water intrusion reducing portion includes a plurality of dense layers that are arranged at intervals in the longitudinal direction and have a porosity of less than 10%, each of the plurality of dense layers being disposed such that a position thereof in the longitudinal direction overlaps an inner circumferential surface of any of the at least one dense body.

In the gas sensor of the invention, the sensor element includes: the detection portion including the plurality of electrodes disposed on the forward end side of the element body; the at least one connector electrode disposed on the rear end side of the prescribed one of the at least one side surface; the porous layer that covers at least the forward end side of the prescribed side surface; and the water intrusion reducing portion disposed on the prescribed side surface so as to be located rearward of at least part of the porous layer and to be located forward of the connector electrode. The sensor element includes the water intrusion reducing portion. Therefore, in the case where the forward end side of the sensor element (element body), i.e., the side on which the plurality of electrodes are present, is exposed to the measurement-object gas, even when water (moisture) in the measurement-object gas moves by capillary action through the porous layer toward the rear end side of the sensor element in the longitudinal direction, the water reaches the water intrusion reducing portion before it reaches the connector electrode. The water intrusion reducing portion includes the plurality of dense layers that are arranged at intervals in the longitudinal direction, and each of the plurality of dense layers is disposed such that its position in the longitudinal direction overlaps the inner circumferential surface of any of the at least one dense body. The dense layers have a smaller porosity than the porous layer and reduce the capillary action of water in the longitudinal direction. A forward end portion, with respect to the longitudinal direction, of each dense layer has a higher effect of reducing the migration of water in the longitudinal direction than central and rear end portions with respect to the longitudinal direction. Therefore, since the water intrusion reducing portion includes the plurality of dense layers arranged at intervals in the longitudinal direction, the water moving in the longitudinal direction can be further prevented than that when the water intrusion reducing portion includes only one dense layer.

The inventors have confirmed these findings through experiments and analysis. Therefore, the water moving beyond the water intrusion reducing portion to the rear end side of the sensor element and reaching the connector electrode can be further prevented.

In the gas sensor of the invention, the plurality of dense layers included in the water intrusion reducing portion may include three or more dense layers. Between two of the dense layers that are adjacent in the longitudinal direction, at least the porous layer and a gap region may be formed.

In the gas sensor of the invention, the sensor element may further include an outer lead portion disposed on the prescribed side surface and provided for electrical continuity between any of the plurality of electrodes and the connector electrode. The porous layer may cover at least part of the outer lead portion. In this case, at least part of the outer lead portion can be protected by the porous layer. When the outer lead portion is protected by the porous layer, the porous layer tends to be located at a position close to the connector electrode, and it is therefore highly significant to apply the present invention.

In this case, the porous layer may fully cover a part of the outer lead portion in which the water intrusion reducing portion is not present. The porous layer may fully cover the outer lead portion except for a region extending from the forwardmost one of the plurality of dense layers to the rearmost one of the plurality of dense layers.

Moreover, the plurality of electrodes may include an outer electrode that is electrically continuous with the connector electrode through the outer lead portion and disposed on the prescribed side surface, and the porous layer may cover the outer electrode.

In the gas sensor of the invention, the porous layer may cover at least a first region and a second region of the prescribed side surface, the first region extending from a forward end of the prescribed side surface to a forward end of a forwardmost one of the plurality of dense layers, the second region extending from a rear end of a rearmost one of the plurality of dense layers to the connector electrode.

In the gas sensor of the invention, the element body may have a rectangular parallelepiped shape, and the at least one side surface of the element body may include four side surfaces extending in the longitudinal direction. The at least one connector electrode may include at least one connector electrode disposed on a first prescribed one of the four side surfaces and at least one connector electrode disposed on a second prescribed one of the four side surfaces, the first prescribed side surface and the second prescribed side surface being opposite to each other. The porous layer may cover the first prescribed side surface and the second prescribed side surface, and the water intrusion reducing portion may include a water intrusion reducing portion disposed on the first prescribed side surface and a water intrusion reducing portion disposed on the second prescribed side surface. In this case, the element body may be a layered body including a plurality of stacked layers, and the first prescribed side surface and the second prescribed side surface may be a top surface and a bottom surface, respectively, of the element body with a stacking direction defined as an upward-downward direction.

### BRIEF DESCRIPTION OF THE DRAWINGS

FIG. 1 is a cross-sectional view showing the manner of attaching a gas sensor 10 to a pipe 58.

FIG. 2 is a perspective view of a sensor element 20.

FIG. 3 is a cross-sectional view taken along A-A in FIG. 2.

FIG. 4 is a top view of the sensor element 20.

FIG. 5 is a bottom view of the sensor element 20.

FIG. 6 is an illustration showing the arrangement of a water intrusion reducing portion 90.

FIG. 7 is an illustration showing the arrangement of a water intrusion reducing portion 90 in a comparative embodiment.

### DETAILED DESCRIPTION OF THE INVENTION

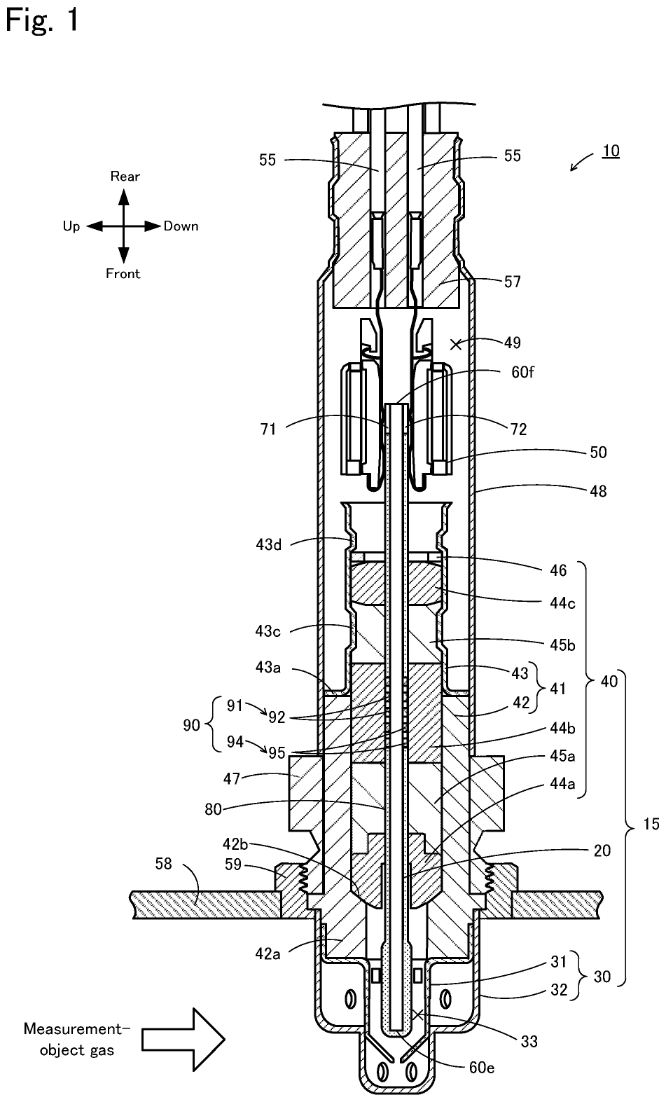

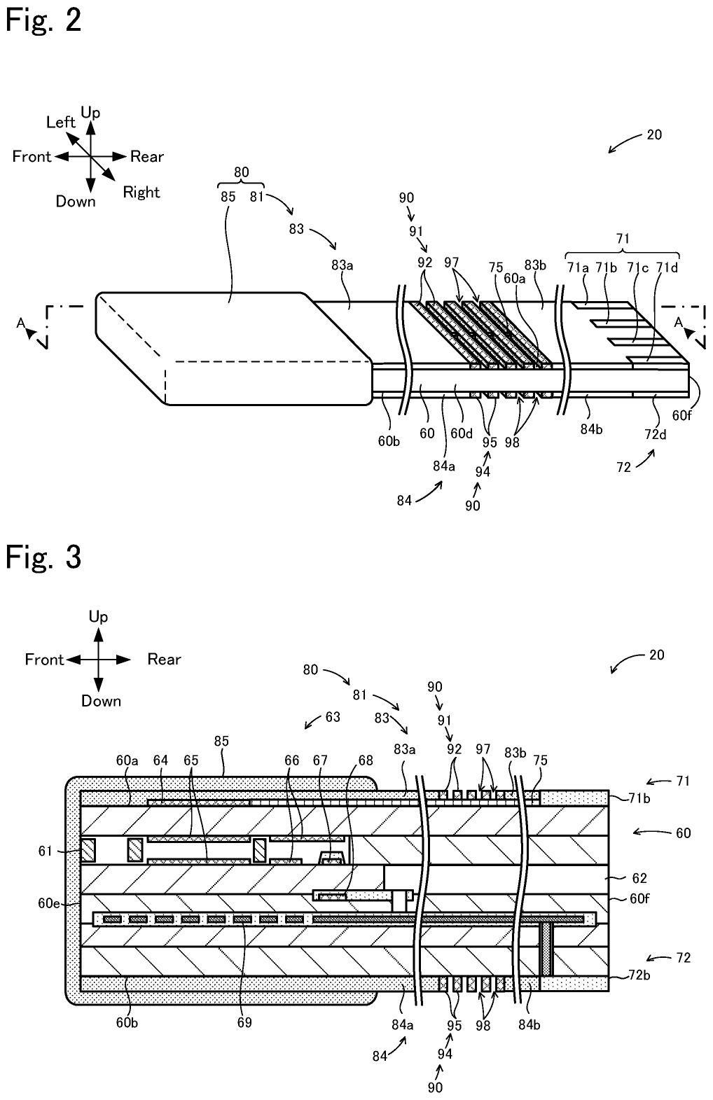

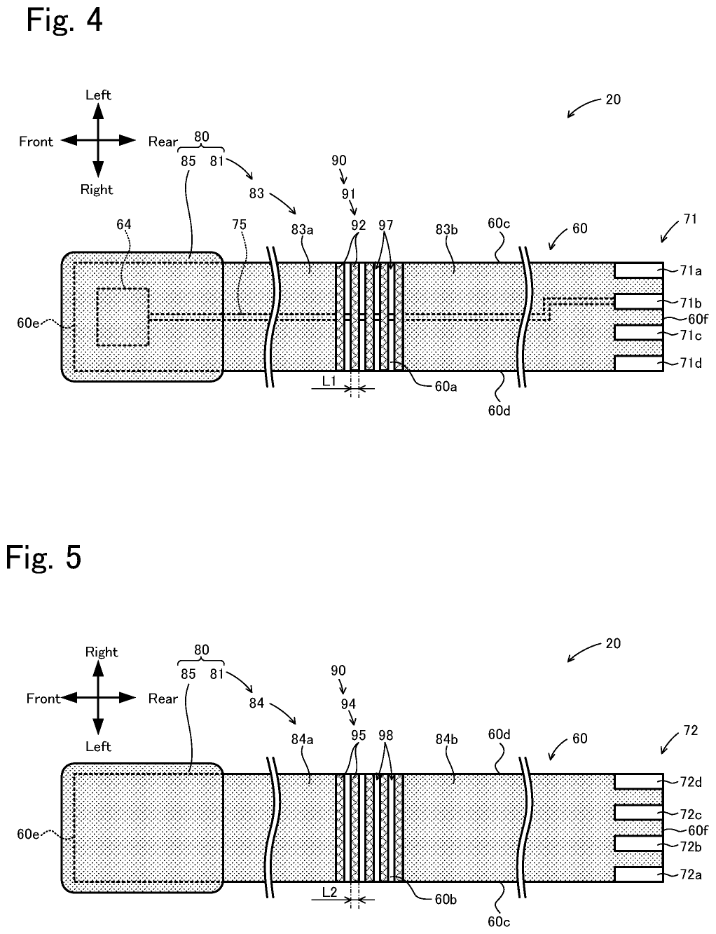

Next, embodiments of the present invention will be described using the drawings. FIG. 1 is a vertical cross-sectional view showing the manner of attaching, to a pipe 58, a gas sensor 10 in an embodiment of the present invention. FIG. 2 is a perspective view of a sensor element 20 when it is viewed from the upper right front. FIG. 3 is a cross-sectional view taken along A-A in FIG. 2. FIG. 4 is a top view of the sensor element 20. FIG. 5 is a bottom view of the sensor element 20. In the present embodiment, as shown in FIGS. 2 and 3, the longitudinal direction of an element body 60 of the sensor element 20 is defined as a forward-rearward direction (lengthwise direction) of the element body 60, and the stacking direction (thickness direction) of the element body 60 is defined as an upward-downward direction. A direction perpendicular to the forward-rearward direction and the upward-downward direction, i.e., a direction passing through the drawing sheet of FIG. 3, is defined as a left-right direction (width direction).

As shown in FIG. 1, the gas sensor 10 includes an assembly 15, a nut 47, an external cylinder 48, a connector 50, lead wires 55, and a rubber stopper 57. The assembly 15 includes the sensor element 20, a protective cover 30, and an element-sealing member 40. The gas sensor 10 is attached to the pipe 58 such as an exhaust gas pipe of a vehicle and used to measure the concentration of a specific gas (a specific gas concentration) such as NOx or O₂ contained in the exhaust gas used as a measurement-object gas. In the present embodiment, the gas sensor 10 measures the concentration of NOx as the specific gas concentration. The sensor element 20 has opposite ends (forward and rear ends) in the longitudinal direction, and the forward end side is the side exposed to the measurement-object gas.

As shown in FIG. 1, the protective cover 30 includes a bottomed cylindrical inner protective cover 31 that covers the forward end side of the sensor element 20 and a bottomed cylindrical outer protective cover 32 that covers the inner protective cover 31. A plurality of holes for allowing circulation of the measurement-object gas are formed in each of the inner and outer protective covers 31 and 32. An element chamber 33 is formed as a space surrounded by the inner protective cover 31, and a fifth surface 60e (forward end surface) of the sensor element 20 is disposed inside the element chamber 33.

The element-sealing member 40 is a member for sealing and fixing the sensor element 20. The element-sealing member 40 includes: a cylindrical member 41 including a metallic shell 42 and an inner cylinder 43; insulators 44a to 44c (examples of the dense body); powder compacts 45a and 45b; and a metal ring 46. The sensor element 20 is disposed so as to extend along the center axis of the element-sealing member 40 (an axis extending in the forward-rearward direction in the present embodiment) and pierces through the element-sealing member 40 in the axial direction.

The metallic shell 42 is a cylindrical metallic member. The metallic shell 42 has a thick-walled portion 42a located on the forward side and having an inner diameter smaller than that of the rear side. The protective cover 30 is attached to a portion of the metallic shell 42 that is on the same side as the forward end of the sensor element 20 (i.e., the forward side). The rear end of the metallic shell 42 is welded to a flange portion 43a of the inner cylinder 43. A part of the inner circumferential surface of the thick-walled portion 42a is formed as a bottom surface 42b that is a step surface. The bottom surface 42b bears the insulator 44a such that the insulator 44a does not protrude forward. The metallic shell 42 has a through hole that passes through the metallic shell 42 in the axial direction (the forward-rearward direction in the present embodiment), and the sensor element 20 passes through the through hole.

The inner cylinder 43 is a cylindrical metallic member and has the flange portion 43a at its forward end. The inner cylinder 43 and the metallic shell 42 are welded to each other so as to be coaxial with each other. The inner cylinder 43 has a reduced diameter portion 43c for pressing the powder compact 45b in a direction toward the center axis of the inner cylinder 43 and a reduced diameter portion 43d for pressing the insulators 44a to 44c and the powder compacts 45a and 45b in the forward direction (toward the lower side in FIG. 1) through the metal ring 46. The inner cylinder 43 has a through hole that passes through the inner cylinder 43 in the axial direction (the forward-rearward direction in the present embodiment), and the sensor element 20 passes through the through hole. The through hole of the metallic shell 42 and the through hole of the inner cylinder 43 are in communication with each other in the axial direction and form the through hole of the cylindrical member 41.

The insulators 44a to 44c and the powder compacts 45a and 45b are disposed between the inner circumferential surface of the through hole of the cylindrical member 41 and the sensor element 20. The insulators 44a to 44c serve as supporters for the powder compacts 45a and 45b. Examples of the material of the insulators 44a to 44c include ceramics such as alumina, steatite, zirconia, spinel, cordierite, and mullite and glass. The insulators 44a to 44c are dense members, and their porosity is, for example, less than 1%. Each of the insulators 44a to 44c is a hollow columnar member having a through hole that passes therethrough in the axial direction (the forward-rearward direction in the present embodiment), and the sensor element 20 passes through the through hole. In the present embodiment, the through hole of each of the insulators 44a to 44c has a quadrilateral cross-section that is perpendicular to the axial direction and conforms to the shape of the sensor element 20. The powder compacts 45a and 45b are formed, for example, by molding a powder and each serve as a sealing medium. Examples of the material of the powder compacts 45a and 45b include talc and ceramic powders such as alumina powder and boron nitride powder, and the powder compacts 45a and 45b may each contain at least one of these materials. Particles included in the powder compacts 45a and 45b may have an average particle diameter of 150 to 300 The powder compact 45a is filled between the insulators 44a and 44b, sandwiched therebetween from opposite sides (forward and rear sides) in the axial direction, and pressed by the insulators 44a and 44b. The powder compact 45b is filled between the insulators 44b and 44c, sandwiched therebetween from opposite sides (forward and rear sides) in the axial direction, and pressed by the insulators 44b and 44c. The insulators 44a to 44c and the powder compacts 45a and 45b are sandwiched between the bottom surface 42b of the thick-walled portion 42a of the metallic shell 42 and both the reduced diameter portion 43d and the metal ring 46 and pressed in the axial direction from opposite sides (the forward and rear sides). The pressing force applied by the reduced diameter portions 43c and 43d causes the powder compacts 45a and 45b to be compressed between the cylindrical member 41 and the sensor element 20, and the powder compacts 45a and 45b close the communication between the element chamber 33 in the protective cover 30 and a space 49 in the external cylinder 48 and fix the sensor element 20.

The nut 47 is fixed to the outer side of the metallic shell 42 so as to be coaxial with the metallic shell 42. The nut 47 has a male thread portion formed on the outer circumferential surface of the nut 47. The male thread portion is screwed into a female thread portion formed on the inner circumferential surface of a fixing member 59 welded to the pipe 58. In this manner, the gas sensor 10 is fixed to the pipe 58 with the forward end side of the sensor element 20 and the protective cover 30 protruding into the pipe 58.

The external cylinder 48 is a cylindrical metallic member and covers the inner cylinder 43, the rear end side of the sensor element 20, and the connector 50. A rear end portion of the metallic shell 42 is inserted into the external cylinder 48. A forward end portion of the external cylinder 48 is welded to the metallic shell 42. The plurality of lead wires 55 connected to the connector 50 are drawn from the rear end of the external cylinder 48 to the outside. The connector 50 is in contact with and electrically connected to upper connector electrodes 71 and lower connector electrodes 72 that are disposed on rear end portions of respective surfaces of the sensor element 20. The lead wires 55 are electrically continuous with electrodes 64 to 68 and a heater 69 that are disposed inside the sensor element 20 through the connector 50. The gap between the external cylinder 48 and the lead wires 55 is sealed by the rubber stopper 57. The space 49 inside the external cylinder 48 is filled with a reference gas. A sixth surface 60f (rear end surface) of the sensor element 20 is disposed inside the space 49.

As shown in FIGS. 2 to 5, the sensor element 20 includes the element body 60, a detection portion 63, the heater 69, the upper connector electrodes 71, the lower connector electrodes 72, a porous layer 80, and a water intrusion reducing portion 90. The element body 60 includes a layered body prepared by stacking a plurality of (six in FIG. 3) oxygen-ion-conductive solid electrolyte layers formed of, for example, zirconia (ZrO₂). The element body 60 has an elongate rectangular parallelepiped shape whose longitudinal direction extends in the forward-rearward direction and has first to sixth surfaces 60a to 60f that are the upper, lower, left, right, forward, and rear outer surfaces of the element body 60. The first to fourth surfaces 60a to 60d are surfaces extending in the longitudinal direction of the element main body 60 and correspond to the side surfaces of the element main body 60. The fifth surface 60e is the forward end surface of the element body 60, and the sixth surface 60f is the rear end surface of the element body 60. As for the dimensions of the element body 60, for example, the length may be from 25 mm to 100 mm inclusive. The width may be from 2 mm to 10 mm inclusive, and the thickness may be from 0.5 mm to 5 mm inclusive. The element body 60 has formed therein: a measurement-object gas inlet 61 having an opening on the fifth surface 60e to introduce the measurement-object gas into the element body 60; and a reference gas inlet 62 having an opening on the sixth surface 60f to introduce the reference gas (air in the present embodiment) used as a reference for detection of the specific gas concentration into the element body 60.

The detection portion 63 is used to detect the specific gas concentration in the measurement-object gas. The detection portion 63 includes a plurality of electrodes disposed on a forward end side of the element body 60. In the present embodiment, the detection portion 63 includes an outer electrode 64 disposed on the first surface 60a and further includes an inner main pump electrode 65, an inner auxiliary pump electrode 66, a measurement electrode 67, and a reference electrode 68 that are disposed inside the element body 60. The inner main pump electrode 65 and the inner auxiliary pump electrode 66 are disposed on the inner circumferential surface of an internal space of the element body 60 and each have a tunnel-like structure.

The principle of the detection of the specific gas concentration in the measurement-object gas by the detection portion 63 is well known, and its detailed description will be omitted. The detection portion 63 detects the specific gas concentration, for example, in the following manner. The detection portion 63 pumps oxygen in the measurement-object gas around the inner main pump electrode 65 to the outside (the element chamber 33) or pumps oxygen from the outside according to a voltage applied between the outer electrode 64 and the inner main pump electrode 65. Moreover, the detection portion 63 pumps oxygen in the measurement-object gas around the inner auxiliary pump electrode 66 to the outside (the element chamber 33) or pumps oxygen from the outside according to a voltage applied between the outer electrode 64 and the inner auxiliary pump electrode 66. This allows the measurement-object gas whose oxygen concentration has been adjusted to a prescribed concentration to reach the measurement electrode 67. The measurement electrode 67 functions as a NOx reduction catalyst and reduces the specific gas (NOx) in the measurement-object gas that has reached the measurement electrode 67. Then the detection portion 63 generates an electric signal corresponding to an electromotive force generated between the measurement electrode 67 and the reference electrode 68 according to the oxygen concentration in the reduced gas or corresponding to a current flowing between the measurement electrode 67 and the outer electrode 64 according to the electromotive force. The electric signal generated by the detection portion 63 is a signal indicating a value corresponding to the specific gas concentration in the measurement-object gas (a value from which the specific gas concentration can be derived) and corresponds to the detection value detected by the detection portion 63.

The heater 69 is an electric resistor disposed inside the element body 60. When electric power is supplied to the heater 69 from the outside, the heater 69 generates heat and heats the element body 60. The heater 69 can heat the solid electrolyte layers included in the element body 60, can keep them hot, and can adjust their temperature to the temperature at which the solid electrolyte layers are activated (e.g., 800° C.).

The upper connector electrodes 71 and the lower connector electrodes 72 are disposed on rear end-side portions of side surfaces of the element body 60 and are electrodes that allow electrical continuity between the element body 60 and the outside. The upper and lower connector electrodes 71 and 72 are not covered with the porous layer 80 and are exposed. In the present embodiment, the upper connector electrodes 71 include four upper connector electrodes 71a to 71d arranged in the left-right direction and disposed on the rear end side of the first surface 60a (upper surface). The lower connector electrodes 72 include four lower connector electrodes 72a to 72d arranged in the left-right direction and disposed on the rear end side of the second surface 60b (lower surface) opposite to the first surface 60a (upper surface). Each of the upper connector electrodes 71a to 71d and the lower connector electrodes 72a to 72d is electrically continuous with a corresponding one of the heater 69 and the plurality of electrodes 64 to 68 of the detection portion 63. In the present embodiment, the upper connector electrode 71a is electrically continuous with the measurement electrode 67, and the upper connector electrode 71b is electrically continuous with the outer electrode 64. The upper connector electrode 71c is electrically continuous with the inner auxiliary pump electrode 66, and the upper connector electrode 71d is electrically continuous with the inner main pump electrode 65. The lower connector electrodes 72a to 72c are electrically continuous with the heater 69, and the lower connector electrode 72d is electrically continuous with the reference electrode 68. The upper connector electrode 71b is electrically continuous with the outer electrode 64 through an outer lead wire 75 disposed on the first surface 60a (see FIGS. 3 and 4). Each of the other connector electrodes is electrically continuous with a corresponding electrode or the heater 69 through a lead wire disposed inside the element body 60, a through hole, etc.

The porous layer 80 is a porous body that covers at least forward end portions of side surfaces of the element body 60 on which the upper and lower connector electrodes 71 and 72 are disposed, i.e., the first and second surfaces 60a and 60b. In the present embodiment, the porous layer 80 includes: inner porous layers 81 that cover the first and second surfaces 60a and 60b; and an outer porous layer 85 disposed on the outer side of the inner porous layers 81.

The inner porous layers 81 include a first inner porous layer 83 that covers the first surface 60a (an example of the first prescribed side surface) and a second inner porous layer 84 that covers the second surface 60b (an example of the second prescribed side surface). The first inner porous layer 83 includes a forward end-side portion 83a and a rear end-side portion 83b (see FIGS. 2 to 4). The forward end-side portion 83a covers a region of the first surface 60a that extends from the forward end of the first surface 60a to a forward end portion of a forwardmost first dense layer 92 of a plurality of first dense layers 92 in a first water intrusion reducing portion 91 (this region is an example of the first region). The rear end-side portion 83b covers a region of the first surface 60a that extends from a rear end portion of a rearmost first dense layer 92 of the plurality of first dense layers 92 to the rear end of the first surface 60a (this region is an example of the second region) except for a region in which the upper connector electrodes 71 are present. The widths of the forward end-side portion 83a and the rear end-side portion 83b of the first inner porous layer 83 in the left-right direction are the same as the width of the first surface 60a in the left-right direction, and the forward end-side portion 83a and the rear end-side portion 83b cover the first surface 60a so as to extend from the left edge of the first surface 60a to its right edge. The first inner porous layer 83 covers at least part of the outer electrode 64 and at least part of the outer lead wire 75. In the present embodiment, as shown in FIGS. 3 and 4, the first inner porous layer 83 fully covers the outer electrode 64 and also fully covers the outer lead wire 75 except for a region extending from the forwardmost first dense layer 92 of the plurality of first dense layers 92 in the first water intrusion reducing portion 91 to the rearmost first dense layer 92. The first inner porous layer 83 serves as a protective layer that protects the outer electrode 64 and the outer lead wire 75 from components of the measurement-object gas such as sulfuric acid and prevents corrosion etc. of the outer electrode 64 and the outer lead wire 75.

The second inner porous layer 84 includes a forward end-side portion 84a and a rear end-side portion 84b (see FIGS. 2, 4, and 5). The forward end-side portion 84a covers a region of the second surface 60b that extends from the forward end of the second surface 60b to a forward end portion of a forwardmost second dense layer 95 of a plurality of second dense layers 95 in a second water intrusion reducing portion 94 (this region is an example of the first region). The rear end-side portion 84b covers a region of the second surface 60b that extends from a rear end portion of a rearmost second dense layer 95 of the plurality of second dense layers 95 to the rear end of the second surface 60b (this region is an example of the second region) except for a region in which the lower connector electrodes 72 are present. The widths of the forward end-side portion 84a and the rear end-side portion 84b of the second inner porous layer 84 in the left-right direction are the same as the width of the second surface 60b in the left-right direction, and the forward end-side portion 84a and the rear end-side portion 84b cover the second surface 60b so as to extend from the left edge of the second surface 60b to its right edge.

The outer porous layer 85 covers the first to fifth surfaces 60a to 60e. The outer porous layer 85 covers the inner porous layers 81 to thereby cover the first surface 60a and the second surface 60b. The length of the outer porous layer 85 in the forward-rearward direction is shorter than that of the inner porous layers 81. Unlike the inner porous layers 81, the outer porous layer 85 covers only the forward end of the element body 60 and a region around the forward end. In this case, the outer porous layer 85 covers a portion of the element body 60 that is located around the electrodes 64 to 68 of the detection portion 63, i.e., a portion of the element body 60 that is disposed inside the element chamber 33 and is to be exposed to the measurement-object gas. Therefore, the outer porous layer 85 serves as a protective layer that reduces the occurrence of cracking in the element body 60 due to adhesion of, for example, moisture etc. in the measurement-object gas.

The porous layer 80 is formed of, for example, a ceramic porous material such as an alumina porous material, a zirconia porous material, a spinel porous material, a cordierite porous material, a titania porous material, or a magnesia porous material. In the present embodiment, the porous layer 80 is formed of an alumina porous material. The thickness of the first inner porous layer 83 and the thickness of the second inner porous layer 84 may be, for example, from 5 μm to 40 μm inclusive. The thickness of the outer porous layer 85 is, for example, from 40 μm to 800 μm inclusive. The porosity of the porous layer 80 is 10% or more. The porous layer 80 covers the outer electrode 64 and the measurement-object gas inlet 61. However, when the porosity of the porous layer 80 is 10% or more, the measurement-object gas can pass through the porous layer 80. The porosity of the inner porous layers 81 may be from 10% to 50% inclusive. The porosity of the outer porous layer 85 may be from 10% to 85% inclusive. The porosity of the outer porous layer 85 may be the same as the porosity of the inner porous layers 81 or may be higher than the porosity of the inner porous layers 81.

The porosity of the inner porous layers 81 is a value derived as follows using an image (SEM image) obtained by observation using a scanning electron microscope (SEM). First, the sensor element 20 is cut in the thickness direction of the inner porous layers 81, and a cross section of one of the inner porous layers 81 is used as an observation surface. The cross-section is embedded in a resin and polished to obtain an observation sample. Next, the magnification of the SEM is set to 1000× to 10000×, and an image of the observation surface of the observation sample is captured to thereby obtain an SEM image of the inner porous layer 81. Next, the image obtained is subjected to image analysis, and a threshold value is determined by a discriminant analysis method (Otsu's binarization) using a brightness distribution obtained from the brightness data of pixels in the image. Using the determined threshold value, the pixels in the image are binarized and classified into object portions and pore portions, and the area of the object portions and the area of the pore portions are computed. Then the ratio of the area of the pore portions to the total area (the total area of the object portions and the pore portions) is computed as a porosity (unit: %). The porosity of the outer porous layer 85 and the porosities of the first dense layers 92 and the second dense layers 95 described later are computed in the same manner as described above.

The water intrusion reducing portion 90 reduces the capillary action of water in the longitudinal direction of the element body 60. In the present embodiment, the water intrusion reducing portion 90 includes the first water intrusion reducing portion 91 and the second water intrusion reducing portion 94. The first water intrusion reducing portion 91 is disposed on the first surface 60a on which the upper connector electrodes 71 and the first inner porous layer 83 are disposed and is located between the forward end-side portion 83a and the rear end-side portion 83b in the longitudinal direction (the forward-rearward direction in the present embodiment) of the element body 60. The first water intrusion reducing portion 91 is disposed closer to the forward end of the element body 60 than the upper connector electrodes 71, i.e., disposed forward of the upper connector electrodes 71. The first water intrusion reducing portion 91 is disposed rearward of the outer electrode 64. The first water intrusion reducing portion 91 is disposed rearward of all the plurality of electrodes 64 to 68, including the outer electrode 64, included in the detection portion 63 (see FIG. 3). The first water intrusion reducing portion 91 plays a role in preventing the water (moisture) that has moved rearward through the forward end-side portion 83a of the first inner porous layer 83 by capillary action and passes through the first water intrusion reducing portion 91 to thereby prevent the water reaching the upper connector electrodes 71. The first water intrusion reducing portion 91 includes a plurality of (five in FIGS. 2 to 4) first dense layers 92. The plurality of first dense layers 92 are disposed on the first surface 60a so as to be arranged at intervals in the longitudinal direction of the element body 60. Each of the first dense layers 92 is a dense layer having a porosity of less than 10%. The width of each of the first dense layers 92 in the left-right direction is the same as the width of the first surface 60a in the left-right direction, and each of the first dense layers 92 covers the first surface 60a so as to extend from the left edge of the first surface 60a to its right edge. The forward end portion of the forwardmost first dense layer 92 of the plurality of first dense layers 92 may be in contact with a rear end portion of the forward end-side portion 83a of the first inner porous layer 83. As shown in FIG. 4, the first dense layers 92 cover part of the outer lead wire 75. A first gap region 97 is formed between each adjacent two of the first dense layers 92 that are adjacent to each other in the longitudinal direction of the element body 60 (four first gap regions 97 are formed in FIGS. 2 to 4). Each of the first gap regions 97 is a region of the first surface 60a in which the porous layer 80 and the first dense layers 92 are not present. The outer lead wire 75 is exposed at portions in which the first gap regions 97 are present.

The second water intrusion reducing portion 94 is disposed on the second surface 60b on which the lower connector electrodes 72 and the second inner porous layer 84 are disposed and is located between the forward end-side portion 84a and the rear end-side portion 84b in the longitudinal direction (the forward-rearward direction in the present embodiment) of the element body 60. The second water intrusion reducing portion 94 is disposed closer to the forward end of the element body 60 than the lower connector electrodes 72, i.e., disposed forward of the lower connector electrodes 72. The second water intrusion reducing portion 94 is disposed rearward of the outer electrode 64. The second water intrusion reducing portion 94 is disposed rearward of all the plurality of electrodes 64 to 68, including the outer electrode 64, included in the detection portion 63 (see FIG. 3). The second water intrusion reducing portion 94 plays a role in preventing the water (moisture) that has moved rearward through the forward end-side portion 84a of the second inner porous layer 84 by capillary action and passes through the second water intrusion reducing portion 94 to thereby prevent the water reaching the lower connector electrodes 72. The second water intrusion reducing portion 94 includes a plurality of (five in FIGS. 2, 3, and 5) second dense layers 95. The plurality of second dense layers 95 are disposed on the second surface 60b so as to be arranged at intervals in the longitudinal direction of the element body 60. Each of the second dense layers 95 is a dense layer having a porosity of less than 10%. The width of each of the second dense layers 95 in the left-right direction is the same as the width of the second surface 60b in the left-right direction, and each of the second dense layers 95 covers the second surface 60b so as to extend from the left edge of the second surface 60b to its right edge. The forward end portion of the forwardmost second dense layer 95 of the plurality of second dense layers 95 may be in contact with a rear end portion of the forward end-side portion 84a of the second inner porous layer 84. A second gap region 98 is formed between each adjacent two of the second dense layers 95 that are adjacent to each other in the longitudinal direction of the element body 60 (four second gap regions 98 are formed in FIGS. 2, 3, and 5). Each of the second gap regions 98 is a region of the second surface 60b in which the porous layer 80 and the second dense layers 95 are not present.

The first dense layers 92 and the second dense layers 95 differ from the porous layer 80 in that their porosity is less than 10%. However, a ceramic composed of any of the materials exemplified for the porous layer 80 described above can be used. In the present embodiment, the first dense layers 92 and the second dense layers 95 are each formed of a ceramic, i.e., alumina. The thickness of each of the first dense layers 92 and the second dense layers 95 may be, for example, from 5 μm to 40 μm inclusive. Preferably, the thickness of each of the first dense layers 92 is equal to or more than the thickness of the first inner porous layer 83. Similarly, preferably, the thickness of each of the second dense layers 95 is equal to or more than the thickness of the second inner porous layer 84. The porosity of each of the first dense layers 92 and the second dense layers 95 is preferably 8% or less and more preferably 5% or less. The smaller the porosity, the further the first dense layers 92 and the second dense layers 95 can reduce the capillary action of water in the longitudinal direction of the element body 60.

The number N1 of first dense layers 92 and the number N2 of second dense layers 95 are the same and are two or more. More preferably, the numbers N1 and N2 are three of more, five or more, or ten or more. The effect of the first dense layers 92 and the second dense layers 95 in reducing the migration of water in the longitudinal direction of the element body 60 is higher in their forward end portion than in their central and rear end portions with respect to the longitudinal direction of the element body 60. Therefore, when a plurality of first dense layers 92 and a plurality of second dense layers 95 are provided, the water moving in the longitudinal direction can be further prevented than that when only one first dense layer 92 and only one second dense layer 95 are provided. The present inventors have confirmed this finding through experiments and analysis. The numbers N1 and N2 may differ from each other.

The length L1 (see FIG. 4) of each of the first dense layers 92 in the longitudinal direction of the element body 60 (the forward-rearward direction in the present embodiment) and the length L2 (see FIG. 5) of each of the second dense layers 95 are the same and are 0.1 mm or more. The lengths L1 and L2 are preferably 0.2 mm or more. The total length Ls1 of the plurality of first dense layers 92 in the longitudinal direction of the element body 60 and the total length Ls2 of the plurality of second dense layers 95 are the same and are 0.5 mm or more. Preferably, the total lengths Ls1 and Ls2 are 5 mm or more or 10 mm or more. When the total lengths Ls1 and Ls2 are 0.5 mm or more, the first dense layers 92 and the second dense layers 95 can reduce the migration of water through the first water intrusion reducing portion 91 and the second water intrusion reducing portion 94 in the longitudinal direction. The present inventors have confirmed this finding through experiments and analysis. The lengths L1 of the first dense layers 92 may differ from each other. The lengths L2 of the second dense layers 95 may differ from each other. The lengths L1 and L2 may differ from each other. The total lengths Ls1 and Ls2 may differ from each other. The plurality of first dense layers 92 may be arranged at regular intervals or irregular intervals in the longitudinal direction of the element body 60. The plurality of second dense layers 95 may be arranged at regular intervals or irregular intervals in the longitudinal direction of the element body 60.

The length of each of the first gap regions 97 and the length of each of the second gap regions 98 in the longitudinal direction of the element body 60 (the forward-rearward direction in the present embodiment) are preferably 1 mm or less. When these lengths are relatively small, the area of portions of the element body 60 in which the first and second surfaces 60a and 60b are exposed, i.e., portions that are not covered with the porous layer 80 and the first and second dense layers 92 and 95, can be reduced. In particular, in the present embodiment, the outer lead wire 75 is disposed on the first surface 60a, so the outer lead wire 75 is exposed in the portions in which the first gap regions 97 are present. Therefore, by reducing the length of each of the first gap regions 97, the area of portions of the outer lead wire 75 that are not protected by the porous layer 80 and the first dense layers 92 can be reduced. The length of each of the first gap regions 97 and the length of each of the second gap regions 98 may be 0.2 mm or more.

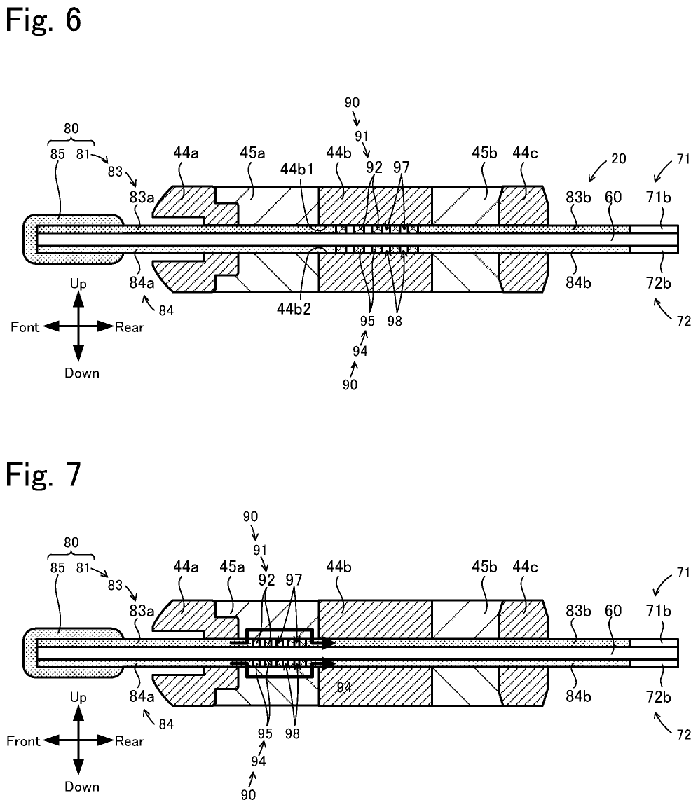

FIG. 6 is an illustration showing the positional relations between the water intrusion reducing portion 90, the insulators 44a to 44c, and the powder compacts 45a and 45b and is a vertical cross-sectional view of the gas sensor 10 with members irrelevant to the description omitted. The first dense layers 92 in the first water intrusion reducing portion 91 and the second dense layers 95 in the second water intrusion reducing portion 94 are disposed such that the positions of the first and second dense layers 92 and 94 in the longitudinal direction (the forward-rearward direction in the present embodiment) of the sensor element 20 overlap inner circumferential surfaces 44b1 and 44b2 of the insulator 44b. The inner circumferential surface 44b1 of the insulator 44b is a surface of the insulator 44b that faces the first dense layers 92, i.e., a surface exposed toward the first dense layers 92, and is an upper-side surface of the inner circumferential surfaces of the insulator 44b that have a quadrangular cross-sectional shape. The inner circumferential surface 44b2 of the insulator 44b is a surface of the insulator 44b that faces the second dense layers 95, i.e., a surface exposed toward the second dense layers 95, and is a lower-side surface of the inner circumferential surfaces of the insulator 44b that have the quadrangular cross-sectional shape.

In FIG. 6, the inner circumferential surface 44b1 of the insulator 44b and the first dense layers 92 in the first water intrusion reducing portion 91 are in contact with each other. However, they may be separated from each other in the upward-downward direction. When they are separated from each other, for example, they are prevented from coming into contact with each other even when they are thermally expanded or the gas sensor 10 vibrates, so that breakage of at least one of the insulator 44b and the sensor element 20 can be prevented. The separation distance between the inner circumferential surface 44b1 of the insulator 44b and the first dense layers 92 at room temperature (for example, 20° C.) may be 50 μm or more. In this case, the migration of water through the gap between the inner circumferential surface 44b1 of the insulator 44b and the first dense layers 92 by capillary action can be prevented. The separation distance is preferably 100 μm or more. The separation distance may be 500 μm or less. In FIG. 6, the inner circumferential surface 44b2 of the insulator 44b and the second dense layers 95 in the second water intrusion reducing portion 94 are also in contact with each other. However, they may be separated from each other in the upward-downward direction. In this case, their separation distance may satisfy at least one of the above numerical ranges.

Next, a method for producing the gas sensor 10 having the above-described structure will be described. A method for producing the sensor element 20 will be described, and then the method for producing the gas sensor 10 including the sensor element 20 installed therein will be described.

The method for producing the sensor element 20 will be described. First, a plurality of (six in the present embodiment) ceramic green sheets corresponding to the element body 60 are prepared. If necessary, notches, through holes, grooves, etc. are punched in the green sheets, and electrodes and wiring patterns are formed on the green sheets by screen printing. Green porous layers that later become the first inner porous layer 83 and the second inner porous layer 84 through firing and green dense layers that later become the first dense layers 92 and the second dense layers 95 through firing are formed by screen printing on surfaces of green sheets that correspond to the first and second surfaces 60a and 60b. Then the plurality of green sheets are stacked. The plurality of stacked green sheets are a green element body that later becomes the element body through firing and that includes the green porous layers and the green dense layers. Then the green element body is fired to obtain the element body 60 including the first inner porous layer 83, the second inner porous layer 84, the first dense layers 92, and the second dense layers 95. Next, the outer porous layer 85 is formed by plasma spraying, and the sensor element 20 is thereby obtained. To produce the porous layer 80, the first dense layers 92, and the second dense layers 95, a gel casting method, dipping, etc. can also be used in addition to screen printing and plasma spraying.

The method for producing the gas sensor 10 including the sensor element 20 installed therein will be described. First, the sensor element 20 is caused to pass through the through hole of the cylindrical member 41 in the axial direction, and the insulator 44a, the powder compact 45a, the insulator 44b, the powder compact 45b, the insulator 44c, and the metal ring 46 are disposed in this order between the inner circumferential surface of the cylindrical member 41 and the sensor element 20. Next, the metal ring 46 is pressed to compress the powder compacts 45a and 45b. With this state maintained, the reduced diameter portions 43c and 43d are formed. The element-sealing member 40 is thereby produced, and the gap between the inner circumferential surface of the cylindrical member 41 and the sensor element 20 is sealed. Then the protective cover 30 is welded to the element-sealing member 40, and the nut 47 is attached to thereby obtain the assembly 15. Then the lead wires 55 caused to pass through the rubber stopper 57 and the connector 50 connected to the lead wires 55 are prepared, and the connector 50 is connected to the rear end side of the sensor element 20. Then the external cylinder 48 is welded and fixed to the metallic shell 42, and the gas sensor 10 is thereby obtained.

Next, an example of the use of the gas sensor 10 having the above-described structure will be described. When the measurement-object gas flows through the pipe 58 with the gas sensor 10 attached to the pipe 58 as shown in FIG. 1, the measurement-object gas flows through the protective cover 30 and into the element chamber 33, and the forward end side of the sensor element 20 is exposed to the measurement-object gas. Then the measurement-object gas passes through the porous layer 80, reaches the outer electrode 64, and also reaches the sensor element 20 through the measurement-object gas inlet 61, and the detection portion 63 generates an electrical signal corresponding to the NOx concentration in the measurement-object gas as described above. By outputting this electrical signal through the upper and lower connector electrodes 71 and 72, the NOx concentration is detected based on the electrical signal.

In this case, the measurement-object gas may contain water (moisture), and the water may move inside the porous layer 80 by capillary action. When the water reaches the exposed upper and lower connector electrodes 71 and 72, the water and sulfuric acid dissolved in the water may cause rust and corrosion in the upper and lower connector electrodes 71 and 72 or a short circuit between adjacent ones of the upper and lower connector electrodes 71 and 72. However, in the gas sensor 10 in the present embodiment, even when water in the measurement-object gas moves inside the porous layer 80 (in particular, the first inner porous layer 83 and the second inner porous layer 84) toward the rear end of the sensor element 20 (the element body 60) by capillary action, the water reaches the first and second water intrusion reducing portions 91 and 94 before it reaches the upper and lower connector electrodes 71 and 72. The first and second water intrusion reducing portions 91 and 94 include the plurality of first dense layers 92 and the plurality of second dense layers 95, respectively, that are arranged at intervals in the longitudinal direction of the element body 60 and have a porosity of less than 10%. Each of the first and second dense layers 92 and 95 has a strong effect of reducing the capillary action of water in the longitudinal direction of the element body 60, and the effect of reducing the migration of water in the longitudinal direction is stronger in the forward end portion than in the central and rear end portions with respect to the longitudinal direction. Therefore, since the plurality of first dense layers 92 and the plurality of second dense layers 95 are provided, the water moving in the longitudinal direction of the element body 60 can be further prevented than that when only one first dense layer 92 and only one second dense layer 95 are provided. In particular, preferably, the numbers N1 and N2 of the first and second dense layers 92 and 95, respectively, are three or more, five or more, or ten or more, and the total lengths Ls1 and Ls2 of the plurality of first dense layers 92 and the plurality of second dense layers 95, respectively, are 5 mm or more or 10 mm or more. The present inventors have confirmed these findings through experiments and analysis. Therefore, the water moving beyond the first and second water intrusion reducing portions 91 and 94 toward the rear end of the sensor element 20 and reaching the upper and lower connector electrodes 71 and 72 can be further prevented.

The first and second dense layers 92 and 95 in the first and second water intrusion reducing portions 91 and 94 are disposed such that their positions in the longitudinal direction of the sensor element 20 (the element body 60) overlap the inner circumferential surface of the insulator 44b. This can prevent water from moving to the rear end side of the sensor element 20 through the outer side of the sensor element 20 so as to detour the pluralities of first and second dense layers 92 and 95. For example, in a comparative embodiment shown in FIG. 7, the first and second dense layers 92 and 95 in the first and second water intrusion reducing portions 91 and 94 are disposed such that their positions in the longitudinal direction of the sensor element 20 overlap the inner circumferential surface of the powder compact 45a. The powder compact 45a is prepared, for example, by molding a powder and has a water absorbing property. In this case, although the migration of water through the pluralities of first and second dense layers 92 and 95 is prevented, water can easily move through the powder compact 45a. Therefore, water moving through the powder compact 45a may move to portions rearward of the pluralities of first and second dense layers 92 and 95 through the outer side of the sensor element 20 so as to detour the pluralities of first and second dense layers 92 and 95 (see thick arrows in FIG. 7). However, as shown in FIG. 6, in the sensor element 20 in the present embodiment, the first and second dense layers 92 and 95 in the first and second water intrusion reducing portions 91 and 94 are disposed such that their positions in the longitudinal direction of the sensor element 20 overlap the inner circumferential surface of the insulator 44b, and the insulator 44b is dense. Therefore, the migration of water to the rear end side of the sensor element 20 through the outer side of the sensor element 20 so as to detour the pluralities of first and second dense layers 92 and 95 can be prevented.

As described above, in the gas sensor 10 in the present embodiment, the first water intrusion reducing portion 91 includes the plurality of first dense layers 92, and therefore the water that has moved through the porous layer 80 (in particular, the forward end-side portion 83a of the first inner porous layer 83) and passes through the plurality of first dense layers 92 can be further prevented than that when the first water intrusion reducing portion 91 includes only one first dense layer 92. Moreover, since the positions of the plurality of first dense layers 92 in the longitudinal direction of the element body 60 overlap the insulator 44b, the water moving so as to detour the plurality of first dense layers 92 can be further prevented than that when the plurality of first dense layers 92 overlap the powder compact 45a or 45b. Therefore, in the gas sensor 10, the water moving beyond the plurality of first dense layers 92 to the rear end side of the sensor element 20 and reaching the upper connector electrodes 71 can be further prevented. Thus, in the sensor element 20, the occurrence of the above-described problem caused by water adhering to the upper connector electrodes 71 can be further prevented.

Similarly, since the second water intrusion reducing portion 94 includes the plurality of second dense layers 95, the water that has moved through the porous layer 80 (in particular, the forward end-side portion 84a of the second inner porous layer 84) and passes through the plurality of second dense layers 95 can be further prevented than that when the second water intrusion reducing portion 94 includes only one second dense layer 95. Moreover, since the positions of the plurality of second dense layers 95 in the longitudinal direction of the element body 60 overlap the insulator 44b, the water moving so as to detour the plurality of second dense layers 95 can be further prevented than that when the plurality of second dense layers 95 overlap the powder compact 45a or 45b. Therefore, in the gas sensor 10, the water moving beyond the plurality of second dense layers 95 to the rear end side of the sensor element 20 and reaching the lower connector electrodes 72 can be further prevented. Thus, in the sensor element 20, the occurrence of the above-described problem caused by water adhering to the lower connector electrodes 72 can be further prevented.

Next, the correspondences between the components in the present embodiment and the components in the present invention will be clarified. The sensor element 20 in the present embodiment corresponds to the sensor element in the invention, and the cylindrical member 41 corresponds to the cylindrical member. The powder compacts 45a and 45b correspond to the powder compact, and the insulators 44a to 44c correspond to the dense body. The element body 60 corresponds to the element body. The detection portion 63 corresponds to the detection portion, and the first and second surfaces 60a and 60b correspond to the prescribed side surface. The upper and lower connector electrodes 71 (71a to 71d) and 72 (72a to 72d) correspond to the connector electrode, and the porous layer 80, particularly the first and second inner porous layers 83 and 84, corresponds to the porous layer. The first and second water intrusion reducing portions 91 and 94 correspond to the water intrusion reducing portion, and the pluralities of first and second dense layers 92 and 95 correspond to the plurality of dense layers. The outer lead wire 75 corresponds to the outer lead portion, and the outer electrode 64 corresponds to the outer electrode.

In the sensor element 20 in the present embodiment described above in detail, since the first water intrusion reducing portion 91 disposed on the first surface 60a of the element body 60 includes the plurality of first dense layers 92 arranged at intervals in the longitudinal direction of the element body 60, the water moving beyond the first water intrusion reducing portion 91 to the rear end side of the sensor element 20 and reaching the upper connector electrodes 71a to 71d can be further prevented than that when the first water intrusion reducing portion 91 includes only one first dense layer 92. Moreover, since the positions of the plurality of first dense layers 92 in the longitudinal direction overlap the insulator 44b, the water moving so as to detour the plurality of first dense layers 92 can be further prevented than that when the plurality of first dense layers 92 overlap the powder compact 45a or 45b. Similarly, since the second water intrusion reducing portion 94 disposed on the second surface 60b of the element body 60 includes the plurality of second dense layers 95 arranged at intervals in the longitudinal direction of the element body 60, the water moving beyond the second water intrusion reducing portion 94 to the rear end side of the sensor element 20 and reaching the lower connector electrodes 72a to 72d can be further prevented than that when the second water intrusion reducing portion 94 includes only one first dense layer 92. Moreover, since the positions of the plurality of second dense layers 95 in the longitudinal direction overlap the insulator 44b, the water moving so as to detour the plurality of second dense layers 95 can be further prevented than that when the plurality of second dense layers 95 overlap the powder compact 45a or 45b. Therefore, the water moving beyond the pluralities of first and second dense layers 92 and 95 to the rear end side of the sensor element 20 and reaching the upper and lower connector electrodes 71 and 72 can be further prevented.

The sensor element 20 includes the outer lead wire 75 that is disposed on the first surface 60a on which the upper connector electrodes 71 are disposed and that provides electric continuity between the outer electrode 64 of the detection portion 63 and the upper connector electrode 71b. The porous layer 80 (particularly, the first inner porous layer 83) covers at least part of the outer lead wire 75. Therefore, at least part of the outer lead wire 75 can be protected by the porous layer 80. When the outer lead wire 75 is protected by the porous layer 80, the porous layer 80 (the first inner porous layer 83) tends to be located at a position close to the upper connector electrodes 71, and it is therefore highly significant to provide the plurality of first dense layers 92 in the first water intrusion reducing portion 91 to thereby further prevent the water reaching the upper connector electrodes 71 through the first inner porous layer 83.

The present invention is not limited to the embodiment described above. It will be appreciated that the present invention can be implemented in various forms so long as they fall within the technical scope of the invention.

For example, in the embodiment described above, the first gap regions 97 are formed such that each is disposed between corresponding two first dense layers 92 in the first water intrusion reducing portion 91 that are adjacent in the longitudinal direction of the element body 60, but this is not a limitation. For example, the first inner porous layer 83 may be formed instead of the first gap regions 97. In this case, the first inner porous layer 83 fully covers the outer electrode 64 and fully covers the outer lead wire 75 except for the plurality of first dense layers 92 in the first water intrusion reducing portion 91. In this manner, the entire outer lead wire 75 can be covered. Alternatively, the first inner porous layer 83 and also a first gap region 97 may be disposed between adjacent two of the first dense layers 92. When three or more first dense layers 92 are provided, i.e., when the number of spaces each formed between corresponding two adjacent first dense layers 92 is two or more, the first inner porous layer 83 may be formed in some of the plurality of spaces. A first gap region 97 may be formed in each of the rest of the spaces. The same applies to the second water intrusion reducing portion 94.

In the embodiment described above, the first inner porous layer 83 includes the forward end-side portion 83a and the rear end-side portion 83b, but the rear end-side portion 83b may not be provided. In this case, a first gap region 97 is formed in a portion in which the rear end-side portion 83b is formed in FIG. 4. The same applies to the second water intrusion reducing portion 94.

In the embodiment described above, the gas sensor 10 includes the three insulators 44a to 44c and the two powder compacts 45a and 45b. However, it is only necessary that the gas sensor 10 include at least one insulator and at least one powder compact. In the embodiment described above, the insulators 44a to 44c are used as examples of the dense body, but this is not a limitation. At least one of the insulators 44a to 44c may be a dense body having a porosity or less than 10%. The dense body having a porosity of less than 10% does not easily allow moisture to pass therethrough and can sufficiently prevent the moisture moving so as to detour the water intrusion reducing portion 90 as described above. The porosity of the dense body may be less than 5%. The porosity of the dense body is a value derived using an SEM in the same manner as that for the porosity of the inner porous layers 81.

In the embodiment described above, the first dense layers 92 in the first water intrusion reducing portion 91 are disposed such that their positions in the longitudinal direction of the sensor element 20 (the forward-rearward direction in the present embodiment) overlap the inner circumferential surface of the insulator 44b, but this is not a limitation. For example, the first dense layers 92 may be disposed such that their positions in the longitudinal direction of the sensor element 20 overlap the inner circumferential surface of the insulator 44a or may be disposed such that their positions in the longitudinal direction of the sensor element 20 overlap the inner circumferential surface of the insulator 44c. Among M first dense layers 92 (M≥3), M1 first dense layers 92 may be disposed such that their positions in the longitudinal direction of the sensor element 20 overlap the inner circumferential surface of the insulator 44a, M2 first dense layers 92 may be disposed such that their positions in the longitudinal direction of the sensor element 20 overlap the inner circumferential surface of the insulator 44b, and M3 first dense layers 92 may be disposed such that their positions in the longitudinal direction of the sensor element 20 overlap the inner circumferential surface of the insulator 44c. It should be noted that “M1+M2+M3=M” holds. When the plurality of first dense layers 92 overlap only a forwardmost one of the plurality of insulators included in the gas sensor 10 (the insulator 44a in the present embodiment), moisture in a gas state in the measurement-object gas may move to the rear end side of the sensor element 20 through gaps between the insulator 44a and the plurality of first dense layers 92. When the plurality of first dense layers 92 overlap only a rearmost one of the plurality of insulators included in the gas sensor 10 (the insulator 44c in the present embodiment), the plurality of first dense layers 92 are relatively close to the upper connector electrodes 71. In this case, although the plurality of first dense layers 92 can prevent the migration of liquid water toward the upper connector electrodes 71 by capillary action, part of the liquid water may be vaporized at a portion forward of the forwardmost first dense layer 92, pass through gaps between the insulator 44c and the plurality of first dense layers 92, and move to the rear end side of the sensor element 20. Therefore, when the number of insulators included in the gas sensor 10 is two or more, it is preferable that at least some of the plurality of first dense layers 92 overlap an insulator other than the forwardmost insulator. When the number of insulators included in the gas sensor 10 is three or more, it is preferable that at least some of the plurality of first dense layers 92 overlap an insulator other than the forwardmost insulator and the rearmost insulator. The same applies to the second dense layers 95 in the second water intrusion reducing portion 94.

In the embodiment described above, the number N1 of first dense layers 92 and the number N2 of second dense layers 95 are each two or more, but this is not a limitation. Only one of them may be two or more.

In the embodiment described above, the sensor element 20 may not include the second inner porous layer 84, and the second surface 60b may not be covered with the porous layer 80. In this case, the sensor element 20 may not include the second water intrusion reducing portion 94. It is only necessary that the water intrusion reducing portion be disposed on at least one of the side surfaces of the element body (the first to fourth surfaces 60a to 60d in the embodiment described above), i.e., at least one side surface on which the connector electrode and the porous protective layer are disposed (at least one of the first and second side surfaces 60a and 60b in the embodiment described above). In this case, at least on the side surface on which the water intrusion reducing portion is disposed, the water passing through the water intrusion reducing portion and reaching the connector electrode can be prevented.

In the embodiment described above, the rear end-side portion 83b of the first inner porous layer 83 covers a region of the first surface 60a that extends from a rear end portion of the rearmost first dense layer 92 of the plurality of first dense layers 92 to the rear end of the first surface 60a except for a region in which the upper connector electrodes 71 are present, but this is not a limitation. For example, the rear end-side portion 83b may cover a region of the first surface 60a that extends from the rear end portion of the rearmost first dense layer 92 of the plurality of first dense layers 92 to forward end portions of the upper connector electrodes 71 or a portion slightly forward of the forward end portions. The same applies to the rear end-side portion of the second inner porous layer 84.

In the embodiment described above, the element body 60 has a rectangular parallelepiped shape, but this is not a limitation. For example, the element body 60 may be cylindrical or circular columnar. In this case, the element body 60 has one side surface.

### EXAMPLES

Examples will next be described. In each Example, sensor elements were actually produced. However, the present invention is not limited to the following Examples.

### Comparative Examples 1 to 3 and Examples 1 to 16

Sensor elements were produced by the same production method as that for the sensor element 20 shown in FIGS. 2 to 5 and used for Comparative Examples 1 to 3 and Examples 1 to 16. As shown in Table 1, in Comparative Examples 1 to 3, only one first dense layer 92 was provided. In Examples 1 to 16, a plurality of first dense layers 92 were provided. The number of second dense layers 95 was the same as the number of first dense layers 92, and the placement positions of the second dense layers 95 in the longitudinal direction of the sensor element 20 were the same as those of the first dense layers 92. The total length Ls1 of the lengths L1 of the first dense layers 92 in Comparative Example 1 and Examples 1 to 7, that in Comparative Example 2 and Examples 8 to 14, and that in Comparative Example 3 and Examples 15 and 16 were different from each other. In Comparative Example 1 and Examples 1 to 7, the total length Ls1 was set to 5 mm, and the numbers of first dense layers 92 located at positions overlapping the respective insulators 44b, 44a, and 44c when the sensor element 20 was installed in the gas sensor 10 and the lengths L1 of the first dense layers 92 in the longitudinal direction were changed. The lengths of the first dense layers 92 were set to be the same. In Comparative Example 2 and Examples 8 to 14, the total length Ls1 was set to 10 mm, and the numbers of first dense layers 92 located at positions overlapping the respective insulators 44b, 44a, and 44c when the sensor element 20 was installed in the gas sensor 10 and the lengths L1 of the first dense layers 92 in the longitudinal direction were changed. In Comparative Example 3 and Examples 15 and 16, the total length Ls1 was set to 0.5 mm, and the numbers of first dense layers 92 located at positions overlapping the respective insulators 44b, 44a, and 44c when the sensor element 20 was installed in the gas sensor 10 and the lengths L1 of the first dense layers 92 in the longitudinal direction were changed.

TABLE 1

| | Numbers of | Numbers of | Numbers of | | | |
|---|---|---|---|---|---|---|
| | first dense | first dense | first dense | | | |
| | layers | layers | layers | Length of | | |
| | overlapping | overlapping | overlapping | each first | Total | |
| | insulators | insulators | insulators | dense layers | length | |
| | 44b | 44a | 44c | L1[mm] | Ls1[mm] | Judge |
| Comparative | 1 | 0 | 0 | 5 | 5 | C |
| Example 1 | | | | | | |
| Example 1 | 2 | 0 | 0 | 2.5 | 5 | B |
| Example 2 | 3 | 0 | 0 | 1.7 | 5 | B |
| Example 3 | 1 | 0 | 0 | 0.5 | 5 | A |
| Example 4 | 20 | 0 | 0 | 0.25 | 5 | A |
| Example 5 | 5 | 5 | 0 | 0.5 | 5 | A |
| Example 6 | 5 | 0 | 5 | 0.5 | 5 | A |
| Example 7 | 5 | 3 | 2 | 0.5 | 5 | A |
| Comparative | 1 | 0 | 0 | 10 | 10 | C |
| Example 2 | | | | | | |
| Example 8 | 2 | 0 | 0 | 5 | 10 | B |
| Example 9 | 4 | 0 | 0 | 2.5 | 10 | B |
| Example 10 | 10 | 0 | 0 | 1 | 10 | A |
| Example 11 | 50 | 0 | 0 | 0.2 | 10 | A |
| Example 12 | 10 | 10 | 0 | 0.5 | 10 | A |
| Example 13 | 10 | 0 | 10 | 0.5 | 10 | A |
| Example 14 | 15 | 15 | 10 | 0.25 | 10 | A |
| Comparative | 1 | 0 | 0 | 0.5 | 0.5 | C |
| Example 3 | | | | | | |
| Example 15 | 3 | 0 | 2 | 0.1 | 0.5 | B |
| Example 16 | 5 | 0 | 0 | 0.1 | 0.5 | B |

Each of the sensor elements 20 in Comparative Examples 1 to 3 and Examples 1 to 16 was produced as follows. First, zirconia particles containing 4 mol % of yttria used as a stabilizer, an organic binder, and an organic solvent were mixed, and the mixture was used to prepare six ceramic green sheets by tape molding. Patterns for electrodes etc. were printed on the green sheets. Green porous layers that later became the first inner porous layer 83 and the second inner porous layer 84 through firing were formed by screen printing. The green porous layers were formed using a slurry prepared by mixing a raw material powder (alumina powder), a binder solution (polyvinyl acetal and butyl carbitol), a solvent (acetone), and a pore-forming material. Then the six green sheets were stacked and fired. Element bodies 60 each including first and second inner porous layers 83 and 84 were thereby produced and used for sensor elements 20 in Comparative Examples 1 to 3 and Examples 1 to 16. As for the dimensions of the element bodies 60, their length was 67.5 mm, the width was 4.25 mm, and the thickness was 1.45 mm. The first and second inner porous layers 83 and 84 had a thickness of 20 μm and a porosity of 30%.

[Liquid Intrusion Test]

For each of the sensor elements 20 in Comparative Examples 1 to 3 and Examples 1 to 16, a test was conducted to determine how much liquid intruded into the rear end side of the element body 60 by capillary action when the forward end side of the element body 60 was immersed in the liquid. First, with the forward end (the fifth surface 60e) of the sensor element 20 facing down and the longitudinal direction parallel to the vertical, a portion of the sensor element 20 that extended from the forward end of the element body 60 to a position 20 mm rearward of the forward end (hereinafter referred to as an immersion position) was immersed in a red check solution. The sensor element 20 in this state was left to stand, and the time until the red check solution reached forward end portions of the upper and lower connector electrodes 71 and 72 of the sensor element 20 was measured and used as infiltration time. In Comparative Example 1 and Examples 1 to 7, when the infiltration time was equal to or longer than 0.9 times that in Comparative Example 1 and shorter than 1.1 times that in Comparative Example 1, the sensor element 20 was judged as standard (C). When the infiltration time was equal to or longer than 1.1 times that in Comparative Example 1 and shorter than 1.3 times that in Comparative Example 1, the sensor element 20 was judged as good (B). When the infiltration time was equal to or longer than 1.3 times that in Comparative Example 1, the sensor element 20 was judged as very good (A). Similarly, in Comparative Example 2 and Examples 8 to 14, the judgement was made based on the infiltration time in Comparative Example 2. In Comparative Example 3 and Examples 15 and 16, the judgement was made based on the infiltration time in Comparative Example 3. The red check solution used was R-3B(NT) PLUS manufactured by EISHIN KAGAKU CO., LTD. The red check solution contains 40 to 60 wt % of a hydrocarbon oil, 10 to 20 wt % of a plastic solvent, 1 to 20 wt % of glycol ether, 12 to 50 wt % of a non-ionic surfactant, and 1 to 5 wt % of an oil-soluble azo-based red dye. The density of the red check solution at 20° C. is 0.86 g/cm³, which is smaller than the density of water. In Comparative Examples 1 to 3 and Examples 1 to 16, the sensor element 20 was left to stand with the forward end of the sensor element 20 facing down and the longitudinal direction parallel to the vertical, and the migration of the red check solution to the rear end side of the sensor element 20 through the outer side of the sensor element 20 so as to detour the first and second water intrusion reducing portions 91 and 94 was prevented to thereby simulate a state in which the first dense layers 92 overlapped any of the insulators 44a to 44c.

Table 1 shows the numbers of first dense layers 92 present at positions overlapping the respective insulators 44b, 44a, and 44c, the length L1 of the first dense layers 92 in the longitudinal direction, and the total length Ls1 of the plurality of first dense layers 92 for each of the sensor elements 20 in Comparative Examples 1 to 3 and Examples 1 to 16, and the results of the judgement in the liquid intrusion test are also shown.

As can be seen from Table 1, in Comparative Example 1 and Examples 1 to 7, the total lengths Ls1 and Ls2 of the pluralities of first and second dense layers 92 and 95 were 5 mm. In Examples 1 and 2 in which the numbers of first and second dense layers 92 and 95 were 2 or 3, the results of the liquid intrusion test were good (B). In Examples 3 to 7 in which the numbers of first and second dense layers 92 and 95 were 10 or more, the results of the liquid intrusion test were very good (A). This confirms that, even when the numbers of first and second dense layers 92 and 95 are 2 or 3 unlike those in Comparative Example 1, the pluralities of first and second dense layers 92 and 95 can reduce the migration of water by capillary action. When the numbers of first and second dense layers 92 and 95 are 10 or more and the lengths L1 and L2 of the first and second dense layers 92 and 95 are 0.25 mm or more, the pluralities of first and second dense layers 92 and 95 can sufficiently reduce the migration of water by capillary action. In Examples 3 and 5 to 7 in which the numbers of first and second dense layers 92 and 95 were 10, the results were very good (A), irrespective of the positions of the first and second dense layers 92 and 95, i.e., irrespective of the numbers of first and second dense layers 92 and 95 overlapping the insulators 44b, 44a, and 44c.

As can also be seen from Table 1, in Comparative Example 2 and Examples 8 to 14, the total lengths Ls1 and Ls2 of the pluralities of first and second dense layers 92 and 95 were 10 mm. In Examples 8 and 9 in which the numbers of first and second dense layers 92 and 95 were 2 or 4, the results of the liquid intrusion test were good (B). In Examples 10 to 14 in which the numbers of first and second dense layers 92 and 95 were 10 or more, the results were very good (A). This confirms that, even when the numbers of first and second dense layers 92 and 95 are 2 or 4 unlike those in Comparative Example 1, the pluralities of first and second dense layers 92 and 95 can reduce the migration of water by capillary action. When the numbers of first and second dense layers 92 and 95 are 10 or more and the lengths L1 and L2 of the first and second dense layers 92 and 95 are 0.2 mm or more, the pluralities of first and second dense layers 92 and 95 can sufficiently reduce the migration of water by capillary action.

As can also be seen from Table 1, in Comparative Example 3 and Examples 15 and 16, the total lengths Ls1 and Ls2 of the pluralities of first and second dense layers 92 and 95 were 0.5 mm. In Examples 15 and 16 in which the numbers of first and second dense layers 92 and 95 were 5, the results of the liquid intrusion test were good (B). This confirms that, in Examples 15 and 16, unlike Comparative Example 3, the pluralities of first and second dense layers 92 and 95 can reduce the migration of water by capillary action. However, the effect is slightly lower when the total lengths Ls1 and Ls2 of the pluralities of first and second dense layers 92 and 95 are small.

The present application claims priority from Japanese Patent Application No. 2022-048718 filed Mar. 24, 2022, the entire contents of which are incorporated herein by reference.

What is claimed is:

1. A gas sensor comprising: a sensor element; a cylindrical member having a through hole through which the sensor element passes in an axial direction; at least one powder compact disposed inside the through hole and filled into a space between an inner circumferential surface of the through hole and the sensor element; and at least one hollow columnar dense body which has a porosity of less than 10% and is disposed inside the through hole, through which the sensor element passes, and which presses the powder compact in the axial direction,
wherein the sensor element comprises:
an elongate element body that has forward and rear ends that are ends opposite to each other in the longitudinal direction and at least one side surface extending in a longitudinal direction;
a detection portion that includes a plurality of electrodes disposed on a forward end side of the element body and configured to detect a specific gas concentration in a measurement-object gas;
at least one connector electrode that is disposed on a rear end side of a prescribed one of the at least one side surface and provided for electrical continuity with the outside;
a porous layer that covers at least a forward end side of the prescribed side surface and has a porosity of 10% or more; and
a water intrusion reducing portion disposed on the prescribed side surface so as to be located rearward of at least part of the porous layer and to be located forward of the connector electrode, and
wherein the water intrusion reducing portion includes a plurality of dense layers that are arranged at intervals in the longitudinal direction and have a porosity of less than 10%, each of the plurality of dense layers being disposed such that a position thereof in the longitudinal direction overlaps an inner circumferential surface of any of the at least one dense body.

2. The gas sensor according to claim 1,
wherein the plurality of dense layers included in the water intrusion reducing portion comprise three or more dense layers.

3. The gas sensor according to claim 1,
wherein at least the porous layer and a gap region are formed between two of the dense layers that are adjacent to each other in the longitudinal direction.

4. The gas sensor according to claim 1,
wherein the sensor element further comprises an outer lead portion disposed on the prescribed side surface and provided for electrical continuity between any of the plurality of electrodes and the connector electrode, and
wherein the porous layer covers at least part of the outer lead portion.

5. The gas sensor according to claim 1,
wherein the porous layer covers at least a first region and a second region of the prescribed side surface, the first region extending from a forward end of the prescribed side surface to a forward end of a forwardmost one of the plurality of dense layers, the second region extending from a rear end of a rearmost one of the plurality of dense layers to the connector electrode.

6. The gas sensor according to claim 1,
wherein the element body has a rectangular parallelepiped shape, wherein the at least one side surface of the element body comprises four side surfaces extending in the longitudinal direction,
wherein the at least one connector electrode comprises at least one connector electrode disposed on a first prescribed one of the four side surfaces and at least one connector electrode disposed on a second prescribed one of the four side surfaces, the first prescribed side surface and the second prescribed side surface being opposite to each other,
wherein the porous layer covers the first prescribed side surface and the second prescribed side surface, and
wherein the water intrusion reducing portion comprises a water intrusion reducing portion disposed on the first prescribed side surface and a water intrusion reducing portion disposed on the second prescribed side surface.
